(19) United States
(12) Patent Application Publication
(10) Pub. No.: US 2012/0073400 A1
(43) Pub. Date: Mar. 29, 2012

(54) HANDLEBAR GRIP ASSEMBLY

(76) Inventor: John WANG, Taichung City (TW)

(21) Appl. No.: 12/893,279

(22) Filed: Sep. 29, 2010

(51) Int. Cl. B62K 21/26

(52) U.S. Cl. 74/551.9

(57) ABSTRACT

A handlebar grip assembly of the present invention includes a sleeve, two covers and two clamps. The sleeve has two clamping ends which defines several axial grooves. A first clamping piece is defined between any two adjacent grooves. The first clamping piece is formed with an axial rib and a first lateral rib which crosses through the axial rib. The cover has several second clamping pieces which is adapted for being inserted in the grooves. The second clamping piece is formed with a second lateral rib. The first lateral ribs and the second lateral ribs are coplanar arranged. The clamp has an inner surface which is formed with an annular recess and several axial recesses. The annular recess is adapted for the first lateral ribs and the second lateral ribs to be received therein. The axial recesses are adapted for the axial ribs to be received therein.

### BACKGROUND OF THE INVENTION

1. Field of the Invention

The present invention relates to a handlebar grip of a bicycle.

2. Description of the Prior Art

Conventional handlebar grip has a hard inner tube and a soft outer sleeve. The inner tube is received in and is covered by the outer sleeve, as shown in TW M282905 and U.S. Pat. No. 6,263,759. One end of the inner tube is formed with two protruding pieces. The protruding pieces are received in a clamp. The protruding pieces and the clamp are used to clutch a handlebar of a bicycle. The handlebar is usually scratched by the protruding pieces and the clamp.

Other handlebar grip, as shown in FIG. 6, has an inner tube, an outer sleeve 63, a clamp 65 and a plug 64. The inner tube is provided for a handlebar 61 to be inserted therein. One end of the inner tube is formed with plurality of protruding pieces 62. The protruding pieces 62 are received in the clamp 65. As such, the clamp 65 is divided from the handlebar 61 by the protruding pieces 62. The handlebar 61 may not be scratched by the clamp 65. The plug 64 is disposed on one end of the handlebar 61.

However, the handlebar grip still has several disadvantages. The handlebar may be deformed by the protruding pieces, so that the fitness of the handlebar grip and the handlebar is descended. The plug 64 is just fitted in the handlebar 61. The plug 64 may be easily dropped by an accident.

Another handlebar grip which is obtained by the applicant of the present invention is disclosed in TW M352502. The handlebar grip has a similar structure and similar disadvantages of the handlebar grip shown in FIG. 6. Moreover, the handlebar of '502 has a protrusion 114. A distal end 111 of the sleeve 11 is formed with the protrusion 114. The protrusion 114 is adapted for the clamp 13 to abut thereagainst so as to prevent the clamp 13 from rotating. However, tightening the clamp 13 may be obstructed by the protrusion 114 in a reason that a gap defined by the clamp 13 may be filled by the protrusion 114.

The present invention is, therefore, arisen to obviate or at least mitigate the above mentioned disadvantages.

### SUMMARY OF THE INVENTION

The main object of the present invention is to provide a dust-proof handlebar grip whose clamp is non-rotatable.

To achieve the above and other objects, a handlebar grip assembly of the present invention includes a sleeve, two covers, two clamps and a tightening means.

The sleeve has two clamping ends. Each one of the clamping ends is formed with at least two axial grooves. A first clamping piece is defined between any two adjacent grooves. The first clamping piece is formed with a first lateral rib and an axial rib. The first lateral rib and the axial rib are located on an outside surface of the first clamping piece. The first lateral rib crosses through the axial rib.

Each one of the covers is disposed on one of the clamping ends. One of the covers has a complete cover plate. The other one of the covers has an annular cover plate. A passing hole is defined about center of the cover plate. The passing hole is adapted for a handlebar to be received therein. Each one of the covers has at least two second clamping pieces corresponding to the grooves. The second clamping pieces are disposed on the cover plates. The second clamping pieces extend axially. The second clamping pieces are received in the grooves, so that the first clamping pieces and the second clamping pieces being circularly arranged. Each one of the second clamping pieces is formed with a second lateral rib. The second lateral rib is located on an outside surface of the second clamping piece. The first lateral ribs and the second lateral ribs are coplanar arranged.

Each one of the clamps has an inner surface and an outer surface. A penetrating hole is defined by the inner surface. The penetrating hole is adapted for the first clamping pieces and the second clamping pieces to be received therein. The clamp is formed with a split. The split extends radially between the inner surface and the outer surface. The clamp is formed with an annular recess and plurality of axial recesses. The annular recess and the axial recesses are located on the inner surface. The annular recess is adapted for the first lateral ribs and the second lateral ribs to be received therein. The axial recesses are adapted for the axial ribs to be received therein.

The tightening means is used to selectively close the clamps up so as to diminish width of the splits. The first clamping pieces and the second clamping pieces are tightened by the clamps inwardly.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a breakdown drawing showing an embodiment of the present invention;

FIG. 2 is a combination drawing showing an embodiment of the present invention;

FIG. 3 is a partial combination drawing showing an embodiment of the present invention;

FIG. 4 is a cross-sectional drawing showing an embodiment of the present invention;

FIG. 5 is an AA profile of the FIG. 2;

FIG. 6 is a breakdown drawing showing a handlebar grip assembly of prior art.

### DETAILED DESCRIPTION OF THE PREFERRED EMBODIMENTS

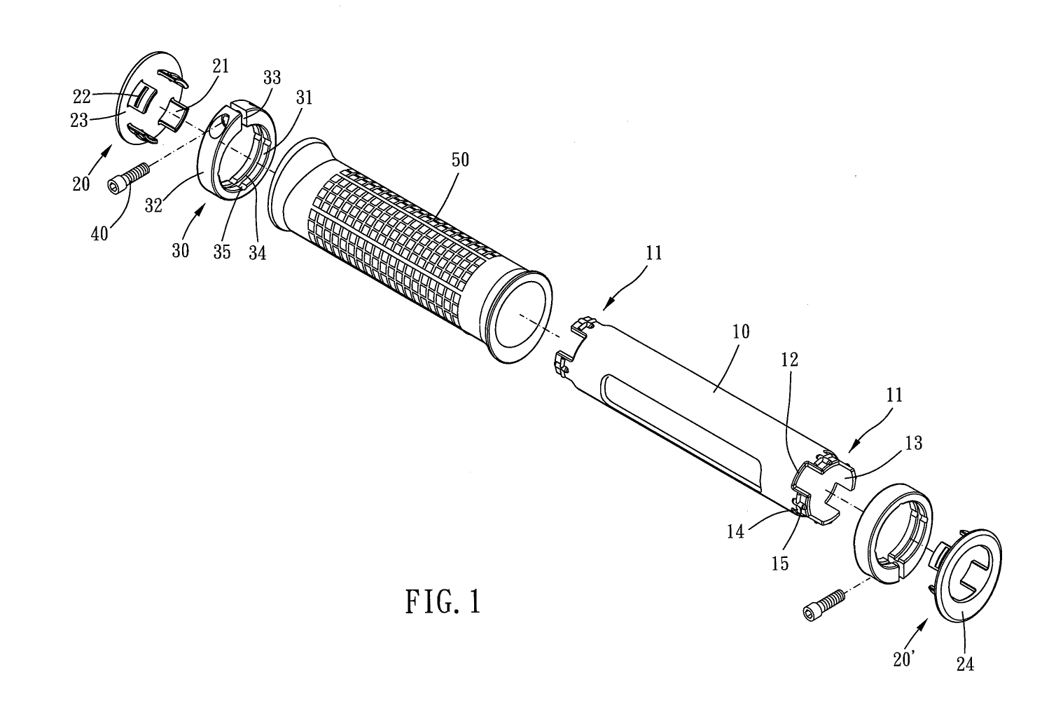

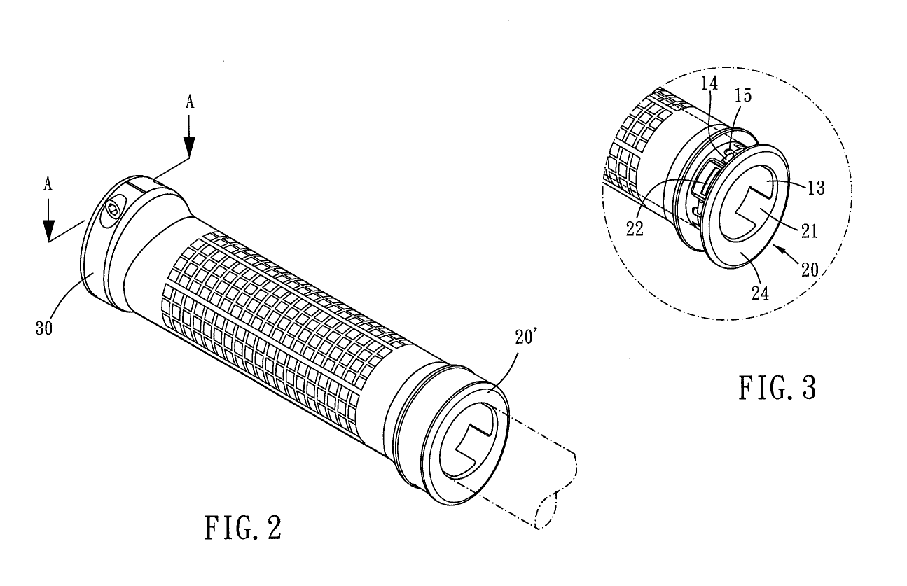

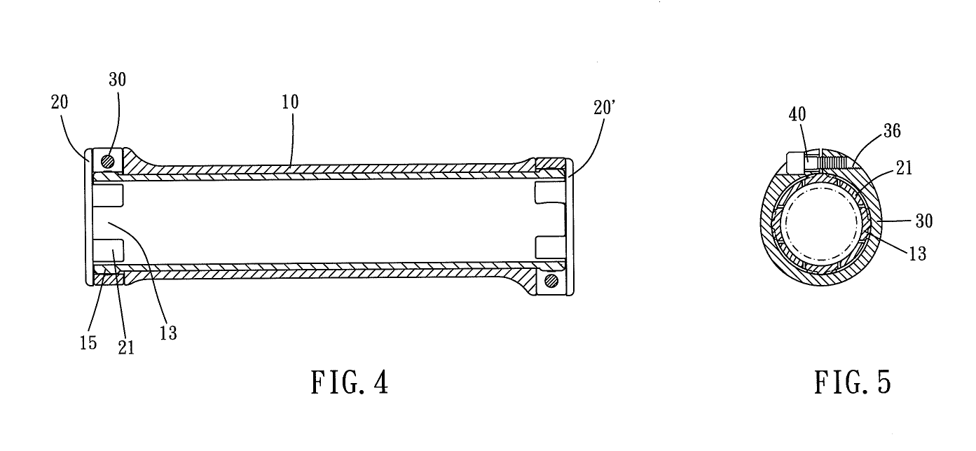

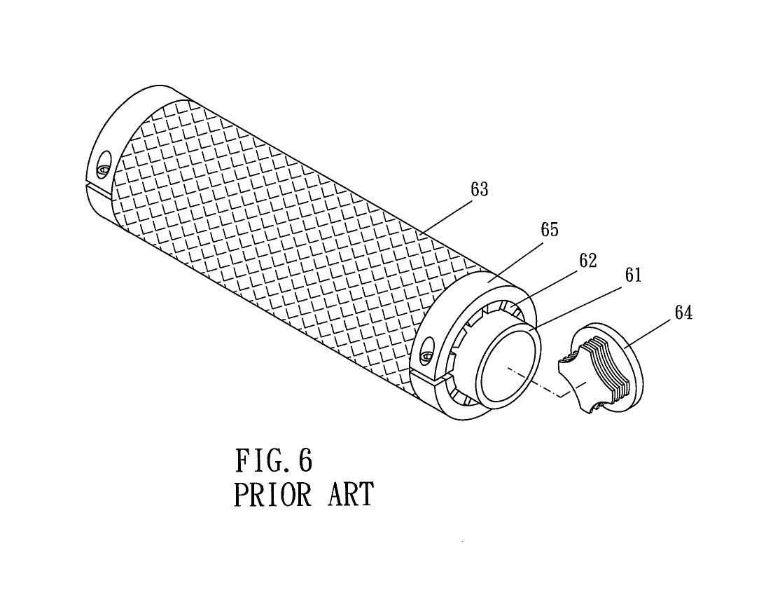

Please refer to FIG. 1 to FIG. 4 for a preferred embodiment of the present invention. The handlebar grip assembly of the present embodiment includes a sleeve 10, two covers 20, two clamps 30 and a tightening means.

The sleeve 10 is made of polypropylene. The sleeve 10 is adapted for a handlebar to be received therein. Preferably, a flexible grip 50, which is made of thermoplastic rubber, is covered on outer surface of the sleeve 10. The sleeve 10 has two clamping ends 11. The clamping end 11 is formed with at least two axial grooves 12. A first clamping piece 13 is defined between any two adjacent grooves 12. The first clamping piece 13 is formed with a first lateral rib 14 and an axial rib 15. The first lateral rib 14 and the axial rib 15 are located on an outside surface of the first clamping piece 13 away from the central axis of the sleeve 10. Preferably, each one of the first clamping pieces has a first lateral rib and an axial rib. The first lateral rib 14 crosses through the axial rib 15. Preferably, the first lateral rib 14 and the axial rib 15 are formed in a cross-shaped protrusion.

The cover 20 may be made of polyamide 6 and be strengthened with glass fiber so as to increase impact tolerance and tensile elastic modulus. The cover 20 is disposed on the clamping end 11. The cover 20 has at least two second clamping pieces 21 corresponding to the grooves 12. The second clamping pieces 21 extend axially. The second clamping pieces 21 are able to be received in the grooves 12 so as to make the first clamping pieces 13 and the second clamping pieces 21 be circularly arranged. The second clamping piece 21 is formed with a second lateral rib 22. The second lateral rib 22 is located on an outside surface of the second clamping piece 21. The second lateral rib 22 and the first lateral rib 14 are coplanar arranged. Preferably, each one of the second clamping pieces has a second lateral rib, so that the second lateral ribs and the first lateral ribs are circularly arranged.

In the present embodiment, the covers, 20 and 20′, further include cover plates 23 and 24. The second clamping pieces 21 are disposed on the cover plates 23 and 24. The cover plate 23 is a complete plate. In other words, the cover plate 23 is formed with no hole. The clamping end 11 is covered by the cover plate 23 so as to block dust out. The cover plate 24 is an annular plate. In other words, a passing hole is defined about center of the cover plate 24. The passing hole is adapted for handlebar to be received therein.

The clamp 30 may be made of metal. The clamp 30 has an inner surface 31 and an outer surface 32. A penetrating hole is defined by the inner surface 31. The penetrating hole is adapted for the first clamping pieces and the second clamping pieces to be received therein. The clamp 30 is formed with a split 33. The split 33 extends radially between the inner surface 31 and the outer surface 32. The clamp 30 is formed with an annular recess 34 and several axial recesses 35. The annular recess 34 and the axial recesses 35 are located on the inner surface 31. The annular recess 34 is adapted for the first lateral ribs 14 and the second lateral ribs 22 to be received therein. The axial recesses 35 are adapter for the axial ribs 15 to be received therein. Preferably, the contour of the cover 20 is leveled with the outer surface 32 of the clamp 30.

The tightening means is used to selectively close the clamp 30 up so as to diminish width of the split 33. The first clamping pieces 13 and the second clamping pieces 21 are tightened by the clamp inwardly. More particularly, the tightening means includes a through hole, a threaded hole 36 and a threaded member 40. The clamp 30 is formed with the through hole and the threaded hole 36. The split 33 is perpendicularly located between the through hole and the threaded hole 36, as shown in FIG. 5. The threaded member 40 is inserted into the through hole and is screwed in the threaded hole 36 so as to selectively close the clamp 30 up by the threaded member 40. In other possible embodiments of the present invention, the tightening means may utilize a pivotable eccentric piece to selectively abut against the clamp. As such, the clamp can be easily closed up.

To conclude, the sleeve 10 may be made of polypropylene, so that the first clamping pieces 13 can cause no scratch on handlebar. In addition, the second lateral ribs 22 are received in the annular recess 34. The covers are engaged with the clamps so as to prevent the covers from dropping. Moreover, the clamps are engaged with the sleeve by the axial ribs and the axial recesses. The clamps are non-rotatable about the central axis of the sleeve.

What is claimed is:

1. A handlebar grip assembly, comprising:
a sleeve, having two clamping ends, each one of the clamping ends being formed with at least two axial grooves, a first clamping piece being defined between any two adjacent grooves, the first clamping piece being formed with a first lateral rib and an axial rib, the first lateral rib and the axial rib being located on an outside surface of the first clamping piece, the first lateral rib crossing through the axial rib;
two covers, each one of the covers being disposed on one of the clamping ends, one of the covers having a complete cover plate, the other one of the covers having an annular cover plate, a passing hole being defined about center of the cover plate, the passing hole being adapted for a handlebar to be received therein, each one of the covers having at least two second clamping pieces corresponding to the grooves, the second clamping pieces being disposed on the cover plates, the second clamping pieces extending axially, the second clamping pieces being received in the grooves, so that the first clamping pieces and the second clamping pieces being circularly arranged, each one of the second clamping pieces being formed with a second lateral rib, the second lateral rib being located on an outside surface of the second clamping piece, the first lateral ribs and the second lateral ribs being coplanar arranged;
two clamps, each one of the clamps having an inner surface and an outer surface, a penetrating hole being defined by the inner surface, the penetrating hole being adapted for the first clamping pieces and the second clamping pieces to be received therein, the clamp being formed with a split, the split extending radially between the inner surface and the outer surface, the clamp being formed with an annular recess and plurality of axial recesses, the annular recess and the axial recesses being located on the inner surface, the annular recess being adapted for the first lateral ribs and the second lateral ribs to be received therein, the axial recesses being adapted for the axial ribs to be received therein;
a tightening means, being used to selectively close the clamps up so as to diminish width of the splits, the first clamping pieces and the second clamping pieces being tightened by the clamps inwardly.

2. The handlebar grip assembly of claim 1, wherein contours of the covers are leveled with the outer surface of the clamp.

3. The handlebar grip assembly of claim 1, wherein the first lateral ribs and the second lateral ribs are circularly arranged.
